(19) United States
(12) Patent Application Publication
(10) Pub. No.: US 2025/0023252 A1
(43) Pub. Date: Jan. 16, 2025

(54) REFLECTING DEVICE HAVING LIQUID CRYSTAL MATERIAL

(71) Applicant: Japan Display Inc., Tokyo (JP)

(72) Inventors: Kazuki MATSUNAGA, Tokyo (JP); Shinichiro OKA, Tokyo (JP); Mitsutaka OKITA, Tokyo (JP); Daiichi SUZUKI, Tokyo (JP)

(73) Assignee: Japan Display Inc., Tokyo (JP)

(21) Appl. No.: 18/898,739

(22) Filed: Sep. 27, 2024

Related U.S. Application Data
(63) Continuation of application No. PCT/JP2023/001962, filed on Jan. 23, 2023.

(30) Foreign Application Priority Data
Mar. 30, 2022 (JP) 2022-057342

(51) Int. Cl. H01Q 15/14; H01Q 3/34; H01Q 21/08

(52) U.S. Cl. CPC H01Q 15/145; H01Q 3/34; H01Q 21/08

(57) ABSTRACT

A reflecting device includes a plurality of patch electrodes arranged in a first direction and in a second direction intersecting the first direction, and a common wiring connecting the plurality of patch electrodes in series in an array along the first direction. Each of the plurality of patch electrodes comprises a first length along the first direction and a second length along the second direction, and the first length is longer than the second length.

### CROSS-REFERENCE TO RELATED APPLICATIONS

This application is a Continuation of International Patent Application No. PCT/JP2023/001962, filed on Jan. 23, 2023, which claims the benefit of priority to Japanese Patent Application No. 2022-057342, filed on Mar. 30, 2022, the entire contents of each are incorporated herein by reference.

### FIELD

An embodiment of the present invention relates to a structure of a reflecting device for radio waves using a liquid crystal material.

### BACKGROUND

A reflecting device for radio waves is a device that controls the scattering direction of incident waves using a periodically arranged array structure of patch electrodes, also called a reflective array. In this specification, reflecting devices for radio waves will also be referred to simply as reflecting device. The reflecting device has a function of reflecting incident waves in a desired direction, and is used, for example, to reflect radio waves in a zone where radio waves are difficult to reach such as between high-rise buildings (blind zone). As a reflecting device, a patch electrode and a metal reflector are arranged between a substrate configured with a dielectric (refer to Japanese Unexamined Patent Application Publication No. 2012-049931).

### SUMMARY

A reflecting device in an embodiment according to the present invention includes a plurality of patch electrodes arranged in a first direction and in a second direction intersecting the first direction, and a common wiring connecting the plurality of patch electrodes in series in an array along the first direction. Each of the plurality of patch electrodes comprises a first length along the first direction and a second length along the second direction, and the first length is longer than the second length.

### BRIEF DESCRIPTION OF DRAWINGS

FIG. 1A is a plan view of a reflecting device according to an embodiment of the present invention.

FIG. 1B is a cross-sectional view corresponding to A-B shown in the plan view of the reflecting device according to an embodiment of the present invention.

FIG. 2A is an illustration of the operation of a unit cell configuring a reflecting device according to an embodiment of the present invention and shows a state in which a bias voltage is not applied to a liquid crystal layer.

FIG. 2B is an illustration of the operation of a unit cell configuring a reflecting device according to an embodiment of the present invention and shows a state in which a bias voltage is applied to a liquid crystal layer.

FIG. 3 is a schematic illustration of a change in the direction of travel of the reflected wave by a reflecting device according to an embodiment of the present invention.

FIG. 4 is a plan view of a patch electrode of a reflecting device according to an embodiment of the present invention.

FIG. 5 is a graph showing the frequency dependence of the reflection amplitude of a reflecting device according to an embodiment of the present invention, as well as the characteristics of a reference example.

FIG. 6A is a graph showing characteristics of a reflecting device according to an embodiment of the present invention, and shows the relationship between aspect ratio of the patch electrode (Ly/Lx) and resonance frequency.

FIG. 6B is a graph showing characteristics of a reflecting device according to an embodiment of the present invention, and shows the relationship between aspect ratio of the patch electrode (Ly/Lx) and resonance frequency.

FIG. 7A is a graph showing a characteristic of a reflecting device according to an embodiment of the present invention, and shows the relationship between a width of a common wiring and a width of a patch electrode (W/Lx) and an aspect ratio of a patch electrode (Ly/Lx) to keep resonance frequency constant.

FIG. 7B is a graph showing a characteristic of a reflecting device according to an embodiment of the present invention, and shows the relationship between a width of a common wiring and a width of a patch electrode (W/Lx) and an aspect ratio of a patch electrode (Ly/Lx) to keep resonance frequency constant.

FIG. 8 is a graph showing an amount of phase shift versus frequency of a radio wave incident on a reflecting device with a resonant frequency of 47 GHz.

FIG. 9 is a graph showing characteristics of a reflecting device according to an embodiment of the present invention, and shows the relationship between a width of a common wiring, a width of a patch electrode (W/Lx), and aspect ratio of a patch electrode (Ly/Lx) for a resonance frequency in the range of ±2 GHz.

FIG. 10 is a plane view of a patch electrode applicable to a reflecting device according to an embodiment of the present invention.

FIG. 11A is a plan view of a reflecting device according to an embodiment of the present invention.

FIG. 11B is a cross-sectional view corresponding to C-D shown in the plan view of the reflecting device according to an embodiment of the present invention.

FIG. 12A is a plan view of a unit cell configuring a reflecting device according to an embodiment of the present invention.

FIG. 12B is a cross-sectional view corresponding to E-F shown in the plan view of a unit cell configuring a reflecting device according to an embodiment of the present invention.

FIG. 13 is a graph showing an example of frequency dependence of a reflection amplitude of reflecting devices.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements like those described previously with respect to previous drawings may be given the same reference sign (or a number followed by A, B, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

### First Embodiment

A reflecting device according to the present embodiment has a function of reflecting incident radio waves in a one-dimensional direction. The details are described below with reference to the drawings.

### 1-1. First Configuration of Reflecting Device

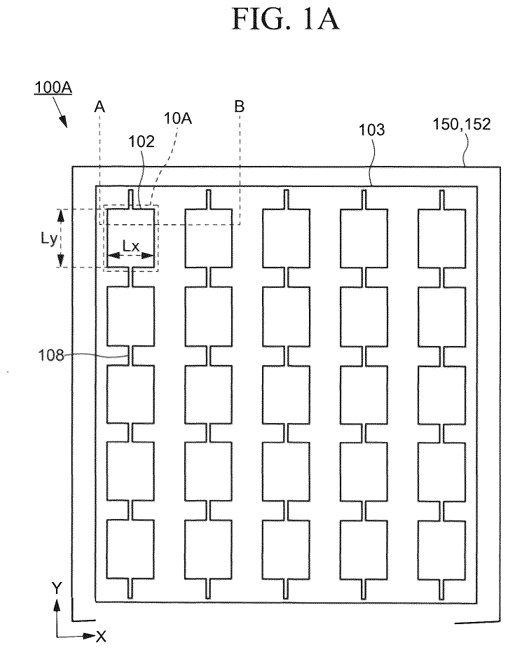

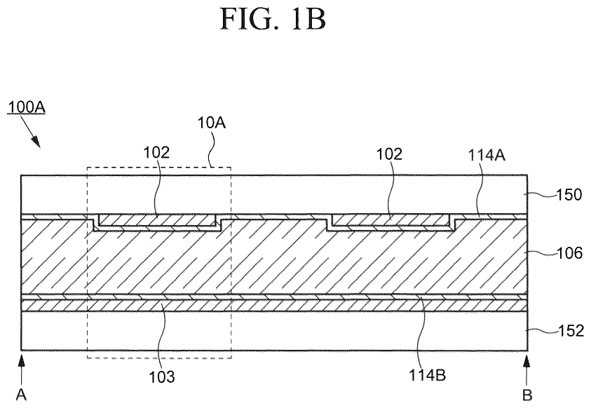

FIG. 1A shows a plan view of a reflecting device 100A, and FIG. 1B shows a cross-sectional view corresponding to A-B shown in the plan view. In the following description, FIG. 1A and FIG. 1B will be referred to as appropriate.

The reflecting device 100A includes a plurality of patch electrodes 102, a reflecting plate 103, and a liquid crystal layer 106. The plurality of patch electrodes 102 are arranged in a first direction and a second direction orthogonal to the first direction. The reflecting plate 103 is arranged on a back side of the plurality of patch electrodes 102. The liquid crystal layer 106 is arranged between the plurality of patch electrodes 102 and the reflecting plate 103.

In this embodiment, the first direction refers to the direction along a Y-axis shown in FIG. 1A, and the second direction refers to the direction along an X-axis shown in FIG. 1A. The first direction and the second direction are used for convenience in describing the arrangement of patch electrodes and the like and the electrode shapes within the arrangement and are not used in the sense of limiting a particular direction.

A first substrate 150 and a second substrate 152 are used as structural materials for the reflecting device 100A. The plurality of patch electrodes 102 are arranged on the first substrate 150 and the reflecting plate 103 is arranged on the second substrate 152. The first substrate 150 and the second substrate 152 are arranged so that the plurality of patch electrodes 102 and the reflecting plate 103 are facing inward and facing each other, and the liquid crystal layer 106 is arranged between them. The reflecting device 100A has a structure in which the plurality of patch electrodes 102 and the reflective plate 103 are arranged so that they face each other with the liquid crystal layer 106 in between. In the reflecting device 100A, the first substrate 150 is arranged on an incident side of radio waves, and the second substrate 152 is arranged on a back side of the first substrate 150. The patch electrode 102 is arranged to reflect radio waves. From this function, the patch electrode 102 can be called a reflecting element.

The plurality of patch electrodes 102 are interconnected by common wiring 108 for each array in the first direction (Y-axis direction). FIG. 1A shows a structure in which the plurality of patch electrodes 102 are connected in series in the first direction (Y-axis direction) by the common wiring 108. A plurality of pairs (or strings) of the plurality of patch electrodes 102 connected in series along the first direction (Y-axis direction) are arranged on the first substrate 150 in the second direction (X-axis direction). A predetermined bias voltage is applied to each pair of the plurality of patch electrodes 102 connected in series along the first direction (Y-axis direction) to align the liquid crystal layer 106. The plurality of patch electrodes 102 are connected in series, which are arranged in the first direction (Y-axis direction), so that a different bias voltage can be applied to each of these rows.

Although not shown in FIG. 1A, a control circuit may be arranged on the first substrate 150 to apply a bias voltage to the plurality of patch electrodes 102. The first substrate 150 may be arranged with terminals for connecting to a controller that drives the reflecting device 100A.

Each of the plurality of patch electrodes 102 has a rectangular shape in a plan view. The patch electrodes 102 have a long side and a short side, with the long side arranged parallel to the first direction (Y-axis direction) and the short side arranged parallel to the second direction (X-axis direction). As shown in FIG. 1A, when a length of the long side of one patch electrode 102 is Ly and a length of the short side is Lx, the relationship is Ly>Lx. In other words, each of the plurality of patch electrodes 102 arranged in the first direction (Y-axis direction) is connected by a common wiring 108, one side along the direction in which the common wiring 108 extends is a long side and has a length Ly, and one side along the direction that intersects the common wiring 108 is the short side and has a length Lx.

The reflecting plate 103 is formed of a conductor and is spread over the entire surface of the second substrate 152. The reflecting plate 103 may be grounded, may have a predetermined voltage applied to it, or may be kept floating. The reflecting plate 103 is sized to overlap all of the plurality of patch electrodes 102.

As shown in FIG. 1B, a first alignment film 114A is arranged on the first substrate 150 and a second alignment film 114B is arranged on the second substrate 152. The first alignment film 114A is arranged to cover the plurality of patch electrodes 102, and the second alignment film 114B is arranged to cover the reflecting plate 103. The first alignment film 114A and the second alignment film 114B are arranged to control the alignment state of the liquid crystal layer 106. The liquid crystal layer 106 contains elongated rod-shaped liquid crystal molecules. The liquid crystal molecules are controlled in their initial alignment state (alignment state in the absence of an electric field) by the first alignment film 114A and the second alignment film 114B.

The alignment state of the liquid crystal molecules in the liquid crystal layer 106 changes with the potential difference between the patch electrode 102 and the reflecting plate 103. The patch electrode 102, the reflective plate 103 opposite the patch electrode 102, and the liquid crystal layer 106 between the patch electrode 102 and the reflective plate 103 are the smallest unit that expresses the function of the reflecting device 100A, which shall be called a unit cell 10A. Details of the unit cell 10A will be described later.

In the reflecting device 100A, the reflective plate 103 is controlled at a constant potential, and a voltage is applied to each pair (or string) of a plurality of patch electrodes 102 connected in series along the first direction (Y-axis direction) to control the alignment state of the liquid crystal molecules. When the alignment of the liquid crystal molecules changes, the relative dielectric constant of the liquid crystal layer 106 changes accordingly. In the reflecting device 100A, a bias voltage that alters the alignment of the liquid crystal layer 106 is applied to each pair (or string) of the plurality of patch electrodes 102 connected in series along the first direction (Y axis direction) to control the direction of travel of the reflected wave.

The liquid crystal layer 106 is formed of a liquid crystal material having dielectric anisotropy. For example, nematic, smectic, cholesteric, and discotic liquid crystals can be used as liquid crystal materials to form the liquid crystal layer 106. The dielectric constant of the liquid crystal layer 106 changes depending on the alignment state of the liquid crystal molecules. The alignment state of the liquid crystal molecules is controlled by the patch electrode 102.

The first substrate 150 and the second substrate 152 are formed of a flat material such as glass, quartz, or resin. Although not shown in FIG. 1B, the first substrate 150 and the second substrate 152 are fixed by a sealant across the liquid crystal layer 106. The liquid crystal layer 106 is sealed within the region enclosed by the first substrate 150, the second substrate 152, and the sealant. The gap between the first substrate 150 and the second substrate 152 is roughly 20 μm to 100 μm, for example, 50 μm. Although not shown, spacers may be arranged between the first substrate 150 and the second substrate 152 to keep the spacing constant.

### 1-2. Unit Cell

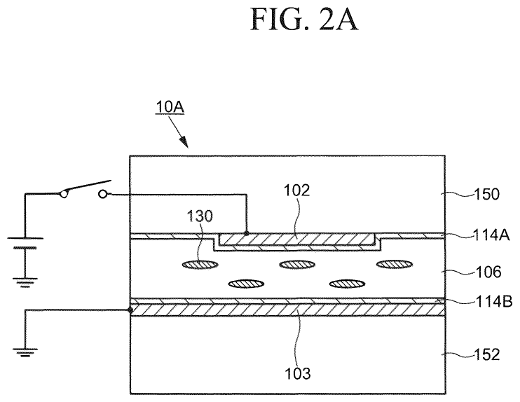

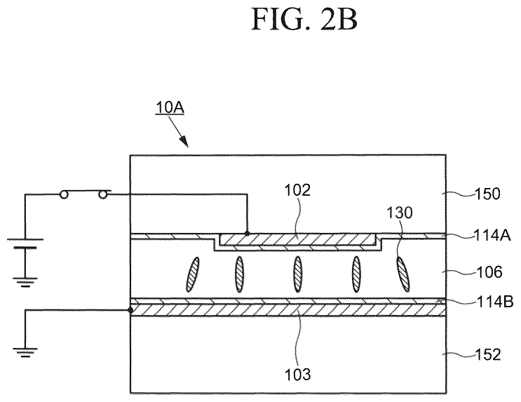

FIG. 2A and FIG. 2B show the operation of the unit cell 10A shown in FIG. 1A. The unit cell 10A is a unit cell configured with one patch electrode 102, the reflecting plate 103, and the liquid crystal layer 106. FIG. 2A and FIG. 2B show that the first alignment film 114A and the second alignment film 114B are horizontally aligned films. FIG. 2A shows that the reflecting plate 103 is grounded and a bias voltage is not applied to the patch electrode 102. In other words, FIG. 2A shows a state in which a voltage is not applied to the patch electrode 102 at a level that alters the alignment state of the liquid crystal molecules. This state is hereinafter referred to as the “first state”. FIG. 2A shows that in the first state, the long axis of the liquid crystal molecules 130 is aligned horizontally (initial alignment state) due to the alignment regulating force of the first alignment film 114A and the second alignment film 114B. In other words, the first state has the long axis direction of the liquid crystal molecules 130 aligned horizontally to the patch electrode 102 and the reflecting plate 103.

FIG. 2B shows a state in which a bias voltage is applied to the patch electrode 102 that alters the alignment state of the liquid crystal molecules 130. This state is hereinafter referred to as the “second state”. In the second state, the long axis direction of the liquid crystal molecules 130 aligns perpendicularly to the surface of the patch electrode 102 and the reflecting plate 103 under the influence of the electric field generated by the bias voltage. The angle at which the long axis of the liquid crystal molecules 130 aligns can be controlled by the magnitude of the bias signal applied to the patch electrode 102, and can be aligned at an angle between horizontal and vertical.

When the liquid crystal molecules 130 have positive dielectric anisotropy, the relative permittivity is larger in the second state (FIG. 2B) relative to the first state (FIG. 2A). When the liquid crystal molecules 130 have negative dielectric anisotropy, the relative permittivity is smaller in the second state (FIG. 2B) relative to the first state (FIG. 2A). The liquid crystal layer 106 formed with liquid crystals having dielectric anisotropy can be regarded as a variable dielectric layer. It is possible to control the unit cell 10A to delay (or not) the phase of the radio wave reflected at the patch electrode 102 by using the dielectric anisotropy of the liquid crystal layer 106.

### 1-3. Function of Reflecting Device

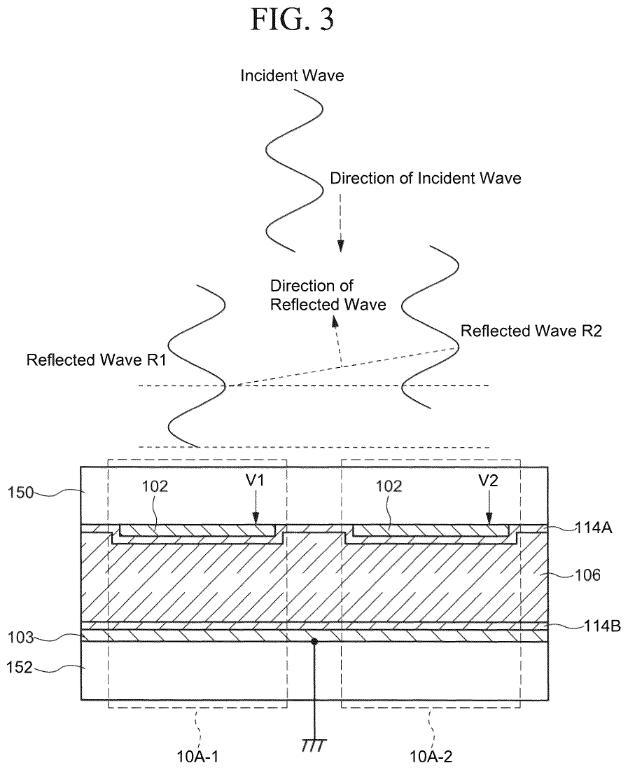

FIG. 3 schematically shows a mode in which the traveling direction of the reflected wave is changed by the first unit cell 10A-1 and the second unit cell 10A-2. FIG. 3 shows that a bias voltage V1 is applied to the patch electrode 102 of the first unit cell 10A-1, a bias voltage V2 is applied to the patch electrode 102 of the second unit cell 10A-2, and the reflecting plate 103 is grounded. The voltage levels of the bias voltage V1 and the bias voltage V2 are different (V1≠V2).

FIG. 3 schematically shows that when a radio wave is incident on the first unit cell 10A-1 and the second unit cell 10A-2 at the same phase, the phase change of the reflected wave by the second unit cell 10A-2 is larger than that of the first unit cell 10A-1, due to different bias voltages (V1 #V2) being applied to the first unit cell 10A-1 and the second unit cell 10A-2. As a result, the phase of the reflected wave R1 reflected by the first unit cell 10A-1 and the phase of the reflected wave R2 reflected by the second unit cell 10A-2 are different (FIG. 3 shows that the phase of the reflected wave R2 is more forward than that of the reflected wave R1), and the apparent direction of the reflected wave changes obliquely.

The frequency bands covered by reflecting device 100A are the very short wave (VHF) band, ultra short wave (UHF) band, microwave (SHF) band, submillimeter wave (THF), millimeter wave (EHF) band, and terahertz wave band. Although the alignment of the liquid crystal molecules in the liquid crystal layer 106 changes with the bias voltage applied to the patch electrode 102, it hardly follows the frequency of the radio waves incident on the patch electrode 102. These characteristics of the liquid crystal molecules allow the phase of the reflected radio waves to be controlled relative to the incident radio waves while the dielectric constant of the liquid crystal layer 106 is changed by the patch electrode 102.

FIG. 3 shows how radio waves are reflected by the pair of unit cells, though, the reflecting device 100A according to the present embodiment has common bias voltages applied to each pair (or string) of the plurality of patch electrodes 102 connected in series along the first direction (Y-axis direction), and the alignment of the liquid crystal layer 106 is controlled. Therefore, the reflecting device 100A according to the present embodiment can change the relative dielectric constant of the liquid crystal layer 106 by the patch electrodes 102 arranged in the first direction (Y-axis direction), thereby changing the direction of travel of the reflected wave in a one-dimensional direction (left/right or up/down direction). According to such a connection structure of the plurality of patch electrodes 102 along one direction, the circuit configuration can be simplified compared to the case where each patch electrode is controlled individually.

Although FIG. 1A shows a configuration in which the plurality of patch electrodes 102 are connected in series in the first direction (Y-axis direction) by the common wiring 108 for each row, the reflecting device 100A according to the present embodiment is not limited to this configuration. For example, the plurality of patch electrodes 102 may have a structure in which they are connected in series by a common wiring 108 in the second direction (X-axis direction), row by row.

### 1-4. Shape of Patch Electrode

The vertical and horizontal dimensions of the patch electrodes are adjusted according to the frequency of the reflected radio waves (considering the resonance frequency). In order to ensure that the individual patch electrodes do not have directivity, the shape of the patch electrodes usually has a square shape in a plan view. On the other hand, radio waves emitted from radio towers have horizontal and vertical polarization and reflecting devices should have the same reflective characteristics for both polarizations.

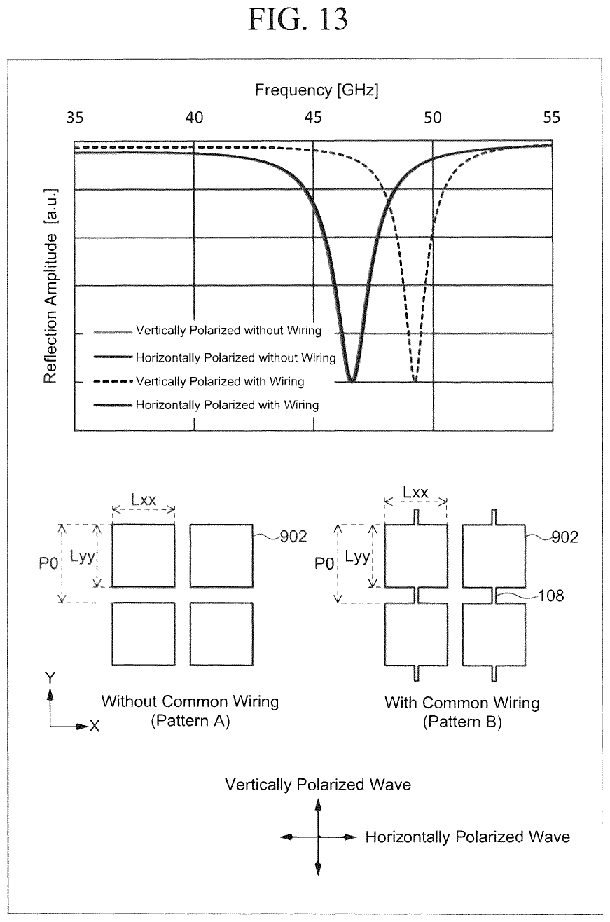

The graph in FIG. 13 shows the results of comparing the reflection characteristics of two electrode patterns, one configuration in which the patch electrodes 902 are arranged individually (Pattern A) and the other configuration in which they are connected in series in one direction (Pattern B), as shown in the inset. As shown in the inset of FIG. 13, the patch electrodes 902 are square, arranged at pitch P0, and have equal length Lxx in the horizontal direction and length Lyy in the vertical direction (Lxx=Lyy). It is assumed for the sake of understanding that the Y-axis direction shown in FIG. 13 is parallel to the oscillation direction of the vertically polarized wave, and the X-axis direction is parallel to the oscillation direction of the horizontally polarized wave.

The graph shown in FIG. 13 shows the frequency (GHz) on the horizontal axis and the reflection amplitude (arbitrary amount) on the vertical axis. From this graph, it can be understood that the electrode structures of Pattern A and Pattern B have minimum reflection amplitude at a specific frequency. The frequency at which the reflection amplitude is minimized is the resonance frequency of the electrode structures of Pattern A and Pattern B. It is considered desirable that the resonant frequency be the same for both vertical and horizontal polarization. The electrode structure of Pattern A is shown in the graph as “Vertically polarized without wiring” and “Horizontally polarized without wiring”, indicating that the resonance frequencies of the vertical and horizontal polarization are identical. On the other hand, the electrode structure of Pattern B is shown in the graph as “Vertically polarized with wiring” and “Horizontally polarized with wiring”, indicating that the resonance frequency of the vertical polarization is shifted to the high frequency side relative to the horizontal polarization. Considering the difference in the electrode structures of Pattern A and Pattern B, the characteristic that the resonance frequency of the vertical polarization shifts to the high frequency side is considered to be caused by the connection of the patch electrode 902 by the common wiring 108. Even in the electrode structure of Pattern B, it is considered necessary to change the electrode structure in order to match the resonance frequency of the vertical and horizontal polarization.

### 1-5. Shape of Patch Electrode

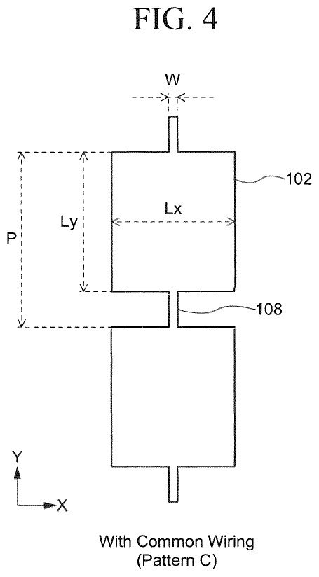

FIG. 4 shows a shape of a patch electrode 102 according to the present embodiment and shows a structure in which two patch electrodes 102 arranged in a first direction (Y-axis direction) are connected by the common wiring 108. In detail, it shows that the patch electrodes 102 have a first length (long edge length) Ly along the first direction (Y-axis direction) and a second length (short edge length) Lx along the second direction (X-axis direction) that intersects (orthogonal to) the first direction and are arranged at a pitch P. The first length (long edge length) Ly and the second length (short edge length) Lx are different (Ly≠Lx). FIG. 4 shows that the common wiring 108 has a width W. The structure of the patch electrode 102 will be referred to as “Pattern C” for convenience. In the following description, the shape of the patch electrode 102 and the common wiring will be described using the first length (long side length) Ly, second length (short side length) Lx, pitch P, and width W shown in FIG. 4.

### 1-6. Frequency Dependence

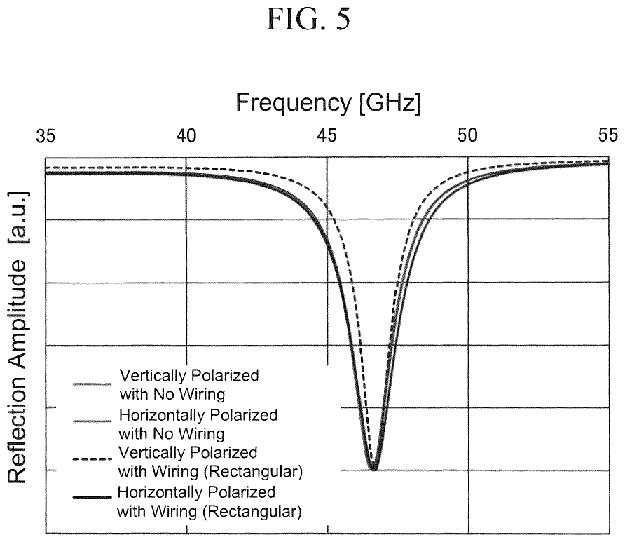

FIG. 5 is a graph showing the frequency dependence of the reflection amplitude of a reflecting device 100A with a structure in which the patch electrode 102 is Pattern C. For comparison, the characteristics of an electrode structure with the patch electrode 902 in Pattern A (refer to FIG. 13) are shown superimposed on this graph. The graph shown in FIG. 5 shows the frequency dependence of the reflection amplitude for each of the vertical polarization and the horizontal polarization. “Wired (rectangular) vertically polarized wave” and “wired (rectangular) horizontally polarized wave” in the graph indicate reflection characteristics of the electrode structure of the Pattern C, and “unwired vertically polarized wave” and “unwired horizontally polarized wave” indicate reflection characteristics of the electrode structure of the Pattern A shown as a reference example.

The patch electrode 102 in Pattern C has a first length (long side length) Ly that is 1.08 times longer than the second length (short side length) Lx, has a rectangular shape in a plan view, and is connected by the common wiring 108. In contrast, the patch electrode 902 of Pattern A has the horizontal length Lxx and the vertical length Lyy equal to each other, has a square shape in a plan view, and has a configuration not connected by the common wiring.

As shown in the graph in FIG. 5, the characteristics of the electrode structure of Pattern C coincide with the resonant frequencies of the vertical polarization and the horizontal polarization. These resonance frequencies also coincide with those in the electrode structure of Pattern A. This result shows that, when the patch electrodes 102 are connected in series along the array in the first direction (Y-axis direction) by the common wiring 108, it is shown that by making a first length (long side length) Ly, which is a direction parallel to the first direction (Y-axis direction), longer than a second length (short side length) Lx, which is perpendicular to the first direction (Y-axis direction), resonance frequencies for a vertically polarized wave and a horizontally polarized wave can be made equal. In other words, this result indicates that the resonance frequencies for the vertical polarization and the horizontal polarization can be matched by extending the patch electrode 102 in the direction of the connection by the common wiring.

### 1-7. Width of Common Wiring

Next, the influence of the width W of the common wiring 108 on the resonance frequency was simulated. The simulation was based on the structure of the patch electrode 102 and the common wiring 108 shown in FIG. 4 to determine whether the relationship between the length Ly in the first direction and the resonance frequency is affected by the width W of the common wiring. The simulation was carried out on the basis of the structure of the patch electrode 102 and the common wiring 108 shown in FIG. 4 to determine whether or not the relationship between the length Ly in the first direction and the resonance frequency is affected by the width W of the common wiring, and how the relationship is affected when it is affected. The simulations in this study were carried out using commercially available electromagnetic field analysis software.

Table 1 shows the resonance frequency when the ratio (Ly/Lx) of the first length (long side length) Ly to the second length (short side length) Lx and the width W of the common wiring change relative to each other. In Table 1, the columns of Ly/Lx=1.00 and wiring width W=0 μm indicate the case where the common wiring 108 is not arranged, and the resonance frequency at this time is 47 GHz. Using the resonance frequency at this time as a reference, Table 1 shows that the smaller the value of Ly/Lx (close to a square) and the larger the width W of the common wiring, the more the resonance frequency shifts to the high frequency side.

TABLE 1

| | Width of Wiring W | | | | | | |
|---|---|---|---|---|---|---|---|
| Ly/Lx | 0 μm | 5 μm | 10 μm | 20 μm | 30 μm | 50 μm | 100 μm |
| 1.00 | 47 | 49.22 | 49.54 | 49.94 | 50.36 | 50.96 | 52.14 |
| 1.01 | | 49.02 | | | | | |
| 1.02 | | | 48.94 | | | | |
| 1.04 | | | | 48.86 | | | |
| 1.04 | | 47.82 | | | | | |
| 1.07 | | 46.94 | | | | | |
| 1.08 | | | 47.04 | | | | |
| 1.09 | | | | | | 48.62 | |
| 1.10 | | | | 47.34 | | | |
| 1.10 | | 46.2 | | | | | |
| 1.11 | | | | 47.1 | | | |
| 1.12 | | | | | | 48.08 | |
| 1.13 | | 45.6 | 46.06 | 46.7 | 47.16 | | |
| 1.14 | | | | | 47.02 | | 49.24 |
| 1.15 | | | 45.84 | | | | |
| 1.15 | | | | | | | 49.14 |
| 1.16 | | 45.32 | 45.72 | 46.38 | | | |
| 1.17 | | | | | | 47.6 | |

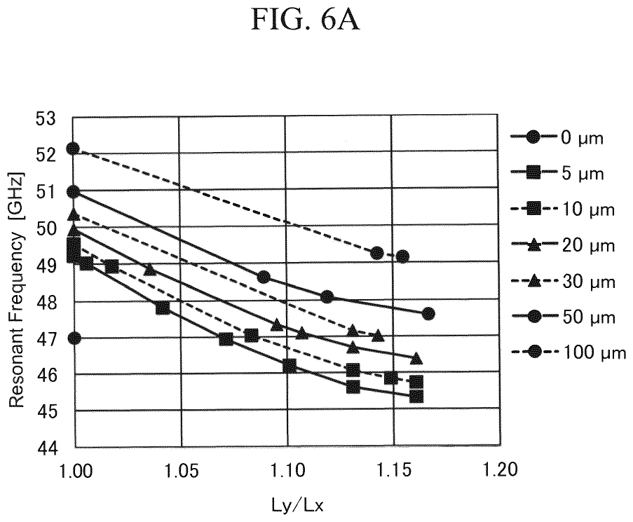

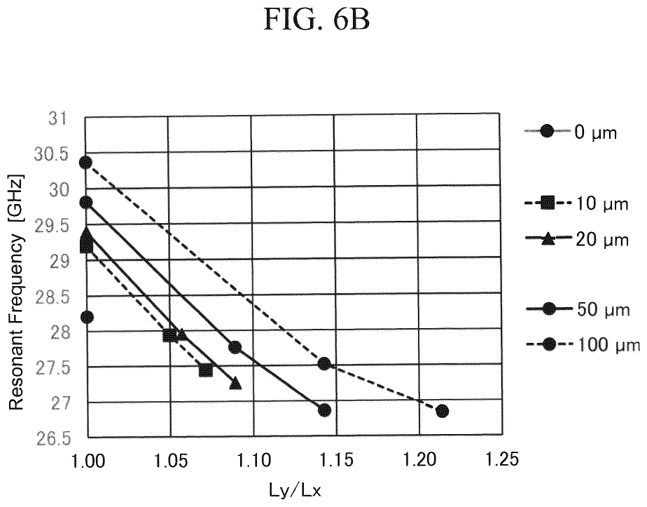

FIG. 6A is a graph showing the change in resonance frequency with respect to the ratio (Ly/Lx) of the first length (long side length) Ly to the second length (short side length) Lx, with the width W of the common wiring as a parameter, and is a graphical representation of the data in Table 1. It can be understood from the graph shown in FIG. 6A that the resonance frequency tends to be lower as the value of Ly/Lx becomes larger (more rectangular), and the resonance frequency tends to be higher as the width W of the common wiring becomes larger.

Table 2 shows the results of a similar simulation set at a resonant frequency of 28.2 GHz. Since the actual dimensions of the first length (long side length) Ly and the second length (short side length) Lx are different from those in Table 1 due to the difference in the resonance frequency, they are shown in relation to Ly/Lx and the width W of the common wiring 108 for comparison. Table 2 also shows that the smaller the value of Ly/Lx (close to a square) and the larger the width W of the common wiring, the more the resonance frequency shifts to the high frequency side.

TABLE 2

| | Width of Wiring W | | | | | | |
|---|---|---|---|---|---|---|---|
| Ly/Lx | 0 μm | 5 μm | 10 μm | 20 μm | 30 μm | 50 μm | 100 μm |
| 1.00 | 28.2 | | 29.195 | 29.39 | | 29.81 | 30.365 |
| 1.05 | | | 27.935 | | | | |
| 1.06 | | | | 27.95 | | | |
| 1.07 | | | 27.44 | | | | |
| 1.09 | | | | 27.26 | | 27.755 | |
| 1.14 | | | | | | 26.855 | 27.515 |
| 1.21 | | | | | | | 26.84 |

FIG. 6B is a graph showing the change in resonance frequency versus the ratio (Ly/Lx) of the first length (long side length) Ly and the second length (short side length) Lx, with the width W of the common wiring as a parameter, it shows a graphical representation of the data in Table 2. It can be understood from the graph shown in FIG. 6B that the resonance frequency tends to be lower as the value of Ly/Lx becomes larger (more rectangular) and the resonance frequency tends to be higher as the width W of the common wiring becomes larger.

From the graphs shown in FIG. 6A and FIG. 6B, it can be understood that the resonance frequency tends to increase for a while in the range of 5 μm to 50 μm in width W of the common wiring 108, and when the width W becomes 100 μm, the resonance frequency shifts significantly to the high frequency side. This result indicates that the increase in the wiring width W of the common wiring can be offset by increasing the first length (long side length) Ly of the patch electrode 102. That is, when the widths of the common wirings 108 are narrowed, the shift of the resonance frequency to the high frequency side can be reduced. However, it is not preferable to make the width W extremely small because the wiring resistance increases. From the graphs shown in FIG. 6A and FIG. 6B, it is understood that when the width W of the common wiring is desired to be increased, the effect of the increase in the width W of the common wiring can be offset by increasing the first length (long side length) Ly of the patch electrode 102, regardless of the resonance frequency. It is considered desirable that the width W of the common wiring 108 be less than 50 μm directly from the characteristics shown in Table 1 and FIG. 6A and FIG. 6B, considering the relationship with Ly/Lx, it is considered desirable to make it less than 3% of the second length (short side length Lx).

When the width W of the common wiring is desired to be increased from the characteristics shown in Table 1 and Table 2 and FIG. 6A and FIG. 6B, it is possible to reduce the shift of the resonance frequency to the high frequency side due to the provision of the common wiring by increasing the first length (long side length) Ly of the patch electrode, and to set the resonance frequency as designed. However, since the patch electrodes 102 are arranged at a predetermined pitch, the first length (long edge length) Ly cannot be increased beyond that pitch. On the other hand, if the resonant frequency is shifted, the amount of phase shift relative to the designed resonant frequency will be reduced, and the function of changing the direction (angle) of the travelling reflected wave as a reflecting device will be compromised.

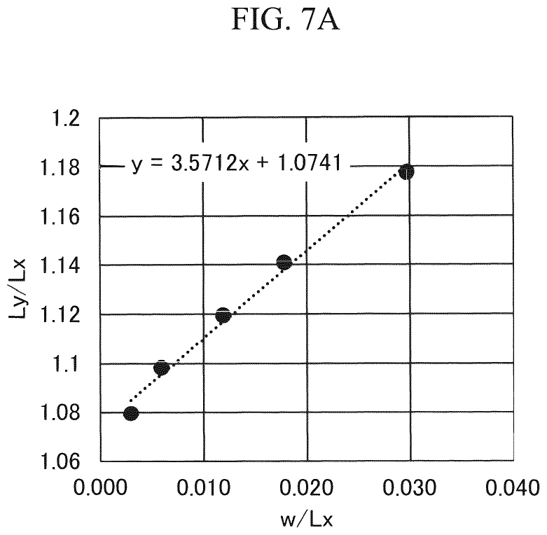

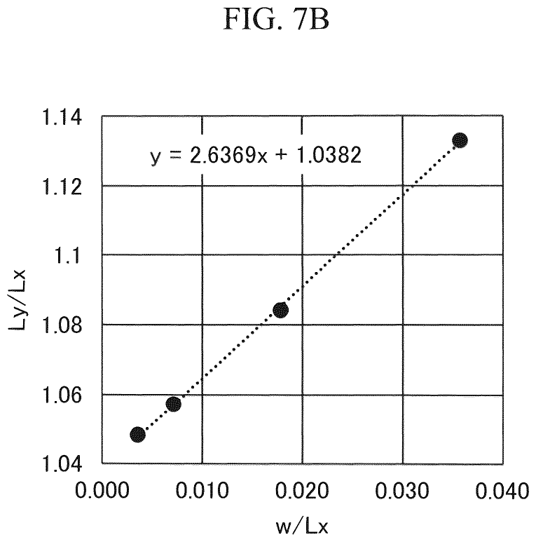

The following is a result of a simulation study on how much width W of the common wiring is acceptable. Table 3 shows the result obtained by linear approximation of the value of Ly/Lx at which the resonance frequency becomes 47 GHz from the graph shown in FIG. 6A by changing the width W of the common wiring while the second length (short side length) Lx of the patch electrode 102 is constant. FIG. 7A is a graph showing the relationship between W/Lx and Ly/Lx shown in Table 3.

TABLE 3

| w [mm] | W/Lx | Ly/Lx |
|---|---|---|
| 0.005 | 0.0029762 | 1.0792845 |
| 0.010 | 0.0059524 | 1.0980375 |
| 0.020 | 0.0119048 | 1.1191293 |
| 0.030 | 0.0178571 | 1.1407427 |
| 0.050 | 0.0297619 | 1.1775830 |

Table 4 shows the result obtained by linear approximation of the value of Ly/Lx at which the resonance frequency becomes 28.2 GHz from the graph shown in FIG. 6B by changing the width W of the common wiring while the second length (short side length) Lx of the patch electrode 102 is constant. FIG. 7B is a graph illustrating the relationship between W/Lx and Ly/Lx shown in Table 4.

TABLE 4

| w [mm] | W/Lx | Ly/Lx |
|---|---|---|
| 0.010 | 0.003571 | 1.048171 |
| 0.020 | 0.007143 | 1.057125 |
| 0.050 | 0.017857 | 1.084031 |
| 0.100 | 0.035714 | 1.132882 |

From the graphs shown in FIG. 7A and FIG. 7B, it is observed that the ratio (Ly/Lx) of the first length (long side length) Ly and the second length (short side length) Lx of the patch electrode linearly increases with respect to the ratio (W/Lx) of the width W of the common wiring and the second length (short side length) Lx of the patch electrode regardless of the resonance frequency. Therefore, when a linear function of y=αx+β is derived from the graph shown in FIG. 7A, where y=(Ly/Lx) and X=(W/Lx), the results α=3.57 and β=1.07 are obtained. Similarly deriving a linear function of y=α′X+β′ from the graph shown in FIG. 7B, the results α′=2.64 and β′=1.04 are obtained.

### 1-8. Aspect Ratio of Patch Electrode and Thickness of Common Wiring

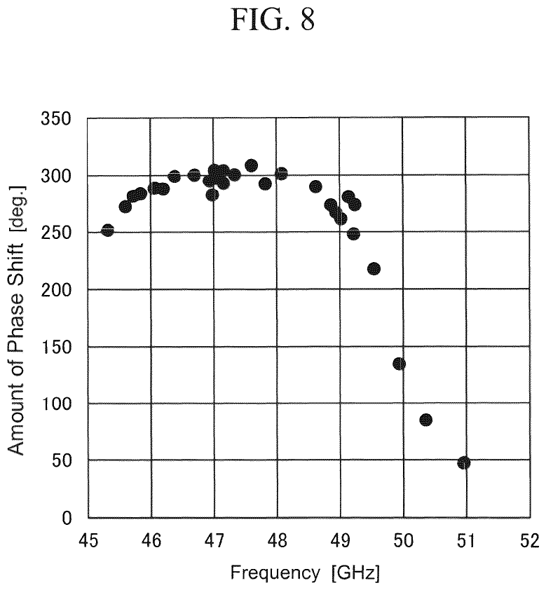

FIG. 8 shows the amount of phase shift that a reflecting device having the frequency shown on the horizontal axis as its resonant frequency can give to an incident wave at 47 GHz. From the graph shown in FIG. 8, it is determined that when the resonant frequency of the reflecting device shifts ±2 GHz from the desired frequency of 47 GHZ, the amount of phase shift relative to 47 GHZ decreases by 10% or more, and the ability to change the angle of the reflected wave decreases.

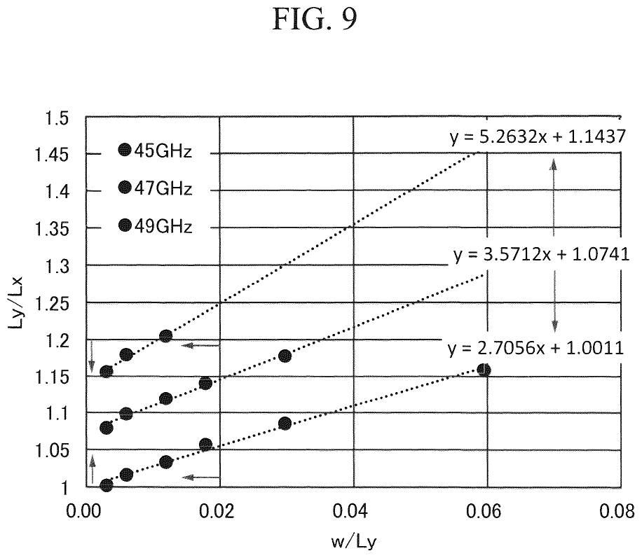

Therefore, the values of α and β are obtained as shown in FIG. 9 by setting ±2 GHz as a shift amount of the resonance frequency as a permissible value. In addition to the results of Table 3, Table 4, Table 5 shows the results obtained by linear approximation of the values of Ly/Lx at resonance frequencies of 45 GHz and 49 GHz from the graph shown in FIG. 6A. FIG. 9 is a graph showing the relationship between W/Lx and Ly/Lx shown in Table 5.

TABLE 5

Ly/Lx

| w [mm] | W/Lx | 45 GHz | 47 GHz | 49 GHz |
|---|---|---|---|---|
| 0.005 | 0.002976 | 1.156225 | 1.079285 | 1.002344 |
| 0.010 | 0.005952 | 1.179719 | 1.098037 | 1.016356 |
| 0.020 | 0.011905 | 1.204784 | 1.119129 | 1.033475 |
| 0.030 | 0.017857 | | 1.140743 | 1.056890 |
| 0.050 | 0.029762 | | 1.177583 | 1.085205 |
| 0.100 | 0.059524 | | | 1.158463 |

On the basis of the graph shown in FIG. 9, when the linear function of y=αX+β was derived, where y=(Ly/Lx) and x=(W/Lx) for each resonance frequency, the linear function of y=2.7056x+1.0011 was obtained at 49 GHZ, and the linear function of y=5.2632x+1.1437 was obtained at 45 GHz. As a result, it was found that α and β in the equation for deriving the ratio (Ly/Lx) of the first length (long side length) Ly and the second length (short side length) of the patch electrode preferably have the following relationship.

2.71<α<5.26

1.00<β<1.14

From the above results, when the plurality of patch electrodes 102 are connected by the common wiring along the arrangement in one direction, the wider the width W of the common wiring 108, the more preferable the direction in which the patch electrodes 102 are connected is the same as the extension method of the long side, and the elongation ratio of the long side to the short side is increased. In the graph shown in FIG. 9, the first length (long side length) Ly of the patch electrode 102 is greater than 1 time of the second length and less than 1.2 times the second length (short side length) Lx (range of Ly/Lx), when the width W of the common wiring 108 is 2% or less (within the range of W/Ly) of the second length (short side length) Lx, the pitch at which the patch electrodes 102 are arranged is not affected, and it is shown that a set (or string) of a plurality of patch electrodes 102 connected in series along the first direction (Y-axis direction) can be configured to be within a range of +2 GHz from the designed resonant frequency.

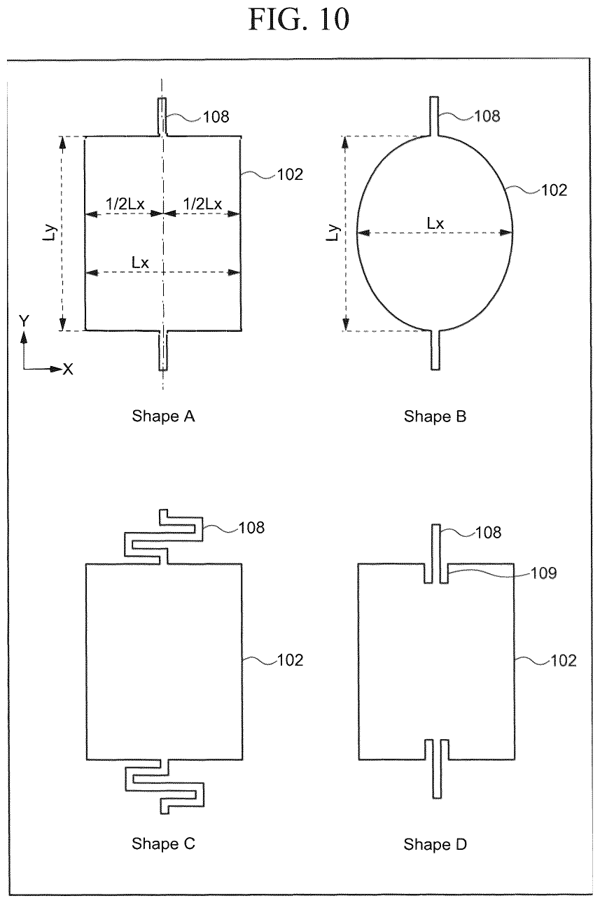

This embodiment shows an example in which the shape of the patch electrode 102 is rectangular (Ly>Lx) in a plan view, such as Shape A shown in FIG. 10, but it is not limited to this shape. For example, it may be an oval shape as shown in FIG. 10, Shape B, as long as the first length Ly and the second length Lx satisfy the relationship Ly>Lx. The common wiring 108 is not limited to a straight shape, but may have a bent shape as shown in Shape C of FIG. 10, or may be bent in a curved shape, which is not shown in the figure. As shown in FIG. 10, Shape D, the patch electrode 102 may have a cutout 109 to bring the connection portion of the common wiring 108 closer to the center of the patch electrode 102.

The connection portion of the common wiring 108 is preferably located at the center point of the second direction (X-axis direction) of the patch electrode 102, as shown in Shape A in FIG. 10. Shapes A to D shown in FIG. 10 are examples in which the long side of the patch electrode 102 is arranged along the first direction (Y-axis direction), but this may be rotated 90 degrees and the long side may be arranged along the second direction (X-axis direction).

As described above, the reflecting device 100A has a plurality of patch electrodes 102 arranged in the first and second directions, the plurality of patch electrodes 102 are connected in series along the array in one direction (first or second direction), and the shape of each patch electrode in a plan view has a shape elongated in one direction. The plurality of patch electrodes 102 connected in series along the unidirectional array have such a shape, which prevents the resonance frequency for vertically or horizontally polarized waves from shifting to the high frequency side (in other words, the resonant frequency can be the same for vertical and horizontal polarization) and allows the direction of travel of the reflected wave to be accurately controlled.

### Second Embodiment

This embodiment shows a reflecting device capable of reflecting incident waves in a two-dimensional direction. In the following description, the focus shall be on the parts that are different from the first embodiment, and the parts in common will be omitted as appropriate.

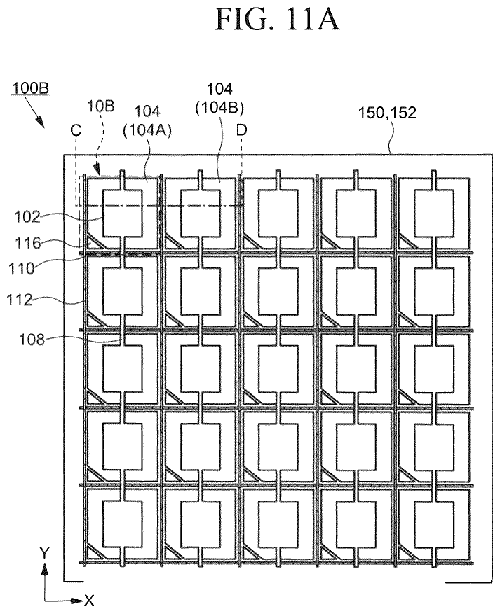

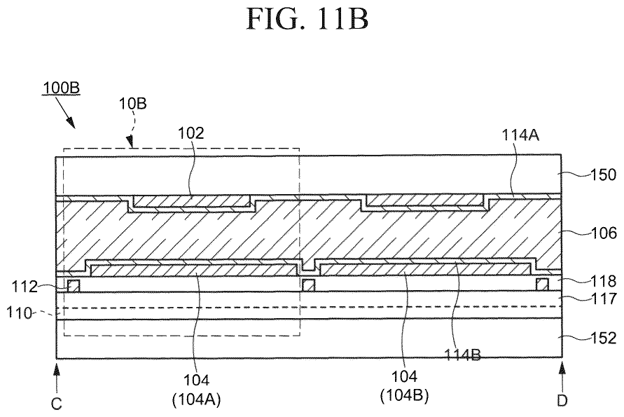

FIG. 11A shows a plan view of a reflecting device 100B, and FIG. 11B shows a cross-sectional view corresponding to C-D shown in the plan view. In the following description, FIG. 11A and FIG. 11B will be referred to as appropriate.

The reflecting device 100B includes a plurality of patch electrodes 102 connected in series by a common wiring 108 in a one-directional array as in the first embodiment. A plurality of control electrodes 104 are arranged in the reflecting device 110B so as to overlap the patch electrodes 102 in a planar view. The control electrodes 104 are electrodes whose applied voltage is individually and independently controlled, and are arranged with a spacing between adjacent electrodes. The plurality of patch electrodes 102 are arranged on the first substrate 150, and the plurality of control electrodes 104 are arranged on the second substrate 152. The liquid crystal layer 106 is arranged between the plurality of patch electrodes 102 and the plurality of control electrodes 104.

As shown in FIG. 11B, a basic unit of the reflecting device 100B can be a structure (which can also include a first substrate 150 and a second substrate 152) in which a set of the patch electrodes (common electrodes) 102, the liquid crystal layer 106, and the control electrode 104 are stacked. Hereafter, this basic unit will be referred to as a unit cell 10B.

As shown in FIG. 11A, selection signal lines 110 extending in the X-axis direction and control signal lines 112 extending in the Y-axis direction are arranged in the reflecting device 100B. The selection signal lines 110 and the control signal lines 112 are arranged to intersect each other through an insulating layer. For example, as shown in FIG. 11B, a first insulating layer 117 and a second insulating layer 118 are arranged on the second substrate 152, and the selection signal lines 110 (shown as dotted lines) and the control signal lines 112 are arranged across the first insulating layer 117.

As shown in FIG. 11A, switching elements 116 are arranged in the X-axis and Y-axis directions corresponding to the control electrodes 104. The switching operation (on/off state) of switching elements 116 are controlled by the selection signal of the selection signal line 110. Each of the switching elements 116 connect each of the control signal lines 112 and the control electrode 104 when on, and operate so that the control signal (control voltage) is applied to the control electrode 104. The switching elements 116 enable control signals (control voltages) to be applied individually to the control electrodes 104 arranged in a matrix.

As shown in FIG. 11B, the first alignment film 114A is arranged on the first substrate 150 and the second alignment film 114B is arranged on the second substrate 152. The first alignment film 114A is arranged to cover the patch electrode (common electrode) 102, and the second alignment film 114B is arranged to cover the control electrode 104. The first alignment film 114A and the second alignment film 114B are arranged to control the alignment state of the liquid crystal layer 106. The liquid crystal layer 106 includes elongated rod-shaped liquid crystal molecules. The liquid crystal molecules are controlled in their initial alignment state (alignment state in the absence of an electric field) by the first alignment film 114A and the second alignment film 114B.

The reflecting device 100B has a function of reflecting radio waves incident on an incident surface in a two-dimensional direction by providing the plurality of control electrodes 104, each of which is individually controlled by an applied voltage. In other words, the reflecting device 100B is capable of applying a bias voltage that controls the alignment of the liquid crystal molecules of the liquid crystal layer 106 for each of the plurality of control electrodes 104, thereby controlling the direction of reflection of incident waves in a two-dimensional direction.

The reflecting device 100B can be regarded as a collection of unit cells 10B. Since the unit cell 10B includes the switching element 116, the control signal (control voltage) applied to the control electrode 104 can be individually controlled for each individual unit cell. Although the patch electrodes 102 are interconnected in the array in the first direction (Y-axis direction), the alignment state of the liquid crystal molecules in the liquid crystal layer 106 can be individually controlled for each unit cell 10B by having the control electrode 104. As the dielectric constant changes when the alignment of the liquid crystal molecules changes, the phase of the reflected radio waves can be different in each of the unit cells 10B.

Although not shown in FIG. 1A and FIG. 1B, the second substrate 152 may be arranged with a driver circuit that outputs a selection signal to the selection signal line 110 and a bias signal to the control signal line 112. Input terminals may be arranged to input signals and drive power to drive these driver circuits.

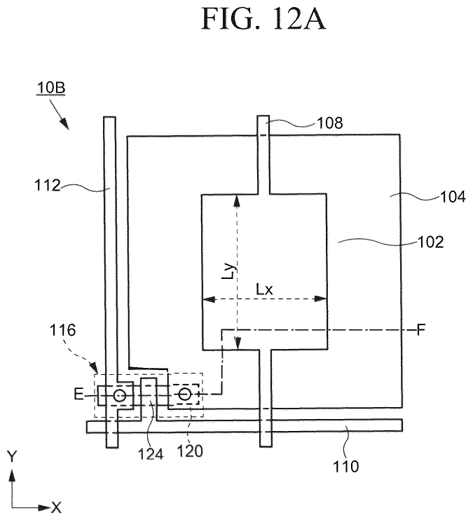

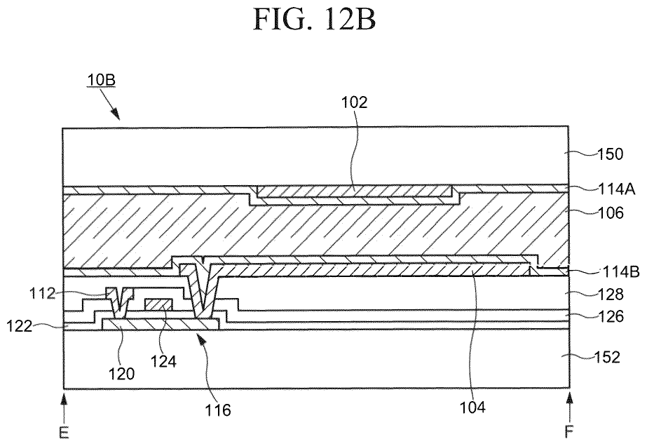

FIG. 12A and FIG. 12B show details of the unit cell 10B configuring the reflecting device 100B. FIG. 12A shows a plan view of the unit cell 10B, and FIG. 12B shows a cross-sectional structure corresponding to E-F shown in the plan view. As shown in FIG. 12A and FIG. 12B, the unit cell 10B is arranged so that the patch electrode 102, liquid crystal layer 106, and control electrode 104 overlap in a plan view.

The patch electrode 102 shown in FIG. 12A has the first length (long side length) Ly and the second length (short side length) Lx, as in the first embodiment. The patch electrode 102 is not limited to a rectangular shape, and the structure of the Shapes B-D as shown in FIG. 10 can be applied. The patch electrode 102 is connected to the common wiring 108 in the first direction (Y-axis direction). The patch electrode 102 and the common wiring 108 are formed, for example, with the same conductive layer.

The control electrode 104 in the unit cell 10B has a function of controlling the alignment state of the liquid crystal layer 106 as well as a function as the reflecting plate. As shown in FIG. 12A, the control electrode 104 has a larger area than the patch electrode 102. The control electrode 104 and the patch electrode 102 overlap, and the patch electrode 102 is arranged in a region inside the control electrode 104.

The switching element 116, the selection signal line 110, and the control signal line 112 are arranged on the second substrate 152. The switching element 116 connects the control signal line 112 to the control electrode 104. The switching operation (on/off operation) of the switching element 116 is controlled by the selection signal of the selection signal line 110.

The control electrode 104 is connected to the control signal line 112 via the switching element 116. FIG. 12A and FIG. 12B show an example in which the switching element 116 is formed by a transistor. The transistor has a structure in which a semiconductor layer 120, a gate insulating layer 122, and a gate electrode 124 are stacked. A first interlayer insulation layer 126 is arranged above the gate electrode 124, and a control signal line 112 is arranged thereon. A second interlayer insulation layer 128 is arranged above the switching element 116 and the control signal line 112. The gate electrode 124 of the switching element (transistor) 116 is connected to the selection signal line 110, one of the input/output terminals (source or drain) is connected to the control signal line 112, and the other is connected to the control electrode 104.

The control electrode 104 is arranged on the second interlayer insulating layer 128. The control electrode 104 is connected to the switching element 116 by a contact hole through the second interlayer insulation layer 128, the first interlayer insulation layer 126, and the gate insulation layer 122.

The control electrode 104 is connected to the control signal line 112 via the switching element 116, and the potential of the control electrode 104 is individually controlled. The selection signal line 110, control signal line 112, and switching element 116, which are arranged on the lower layer side of the control electrode 104, are embedded by the second interlayer insulating layer 128. Since the control electrode 104 is arranged above the second interlayer insulating layer 128, the control electrode 104 can have a large area without being affected by the selection signal line 110, control signal line 112, and switching element 116.

The alignment state of the liquid crystal molecules in the liquid crystal layer 106 is controlled by the control electrode 104. In other words, the alignment state of the liquid crystal molecules in the liquid crystal layer 106 is controlled by the bias signal applied to the control electrode 104. The bias signal is a DC voltage signal or a polarity-reversing DC voltage signal in which positive and negative DC voltages are alternately reversed.

The semiconductor layer 120 is formed of silicon semiconductors such as amorphous silicon, polycrystalline silicon, and oxide semiconductors including metal oxides such as indium oxide, zinc oxide, and gallium oxide. The gate insulating layer 122 and the first interlayer insulating layer 126 are formed of inorganic insulating materials such as silicon oxide, silicon nitride, and silicon nitride oxide. The selection signal line 110 and the gate electrode 124 are configured, for example, of molybdenum (Mo), tungsten (W), or alloys thereof. The control signal line 112 is formed using a metallic material such as titanium (Ti), aluminum (Al), or molybdenum (Mo). For example, the control signal line 112 is configured with a titanium (Ti)/aluminum (Al)/titanium (Ti) laminate structure or a molybdenum (Mo)/aluminum (Al)/molybdenum (Mo) laminate structure. The second interlayer insulating layer 128 is formed of inorganic insulating materials such as silicon oxide, silicon nitride, and silicon nitride oxide, or resin materials such as acrylic and polyimide. The patch electrode (common electrode) 102 and control electrode 104 are formed of a metal film such as aluminum (Al), copper (Cu), or a transparent conductive film such as indium tin oxide (ITO).

The configuration of the unit cell 10B shown in FIG. 12A and FIG. 12B is applied to reflecting device 100B in which the patch electrodes 102 and control electrodes 104 are arranged in a matrix as shown in FIG. 11A. Although the plurality of patch electrodes 102 are connected in series in the first direction (Y-axis direction), since control signals (control voltages) are individually applied to the plurality of control electrodes 104 by the switching elements 116, the alignment of the liquid crystal layer 106 can be controlled for each unit cell 10B.

Since the reflecting device 100B according to the present embodiment has a radio wave incident surface with the plurality of patch electrodes 102 connected along an array in one direction, the plurality of control electrodes 104 arranged behind the surface and capable of individually controlling the applied voltage, and the liquid crystal layer 106 arranged between the two surfaces, it is possible to reflect incoming radio waves in two-dimensional directions (left and right and up and down). In this configuration, the shape in a plan view of each patch electrode connected along one direction has a shape elongated in one direction, which prevents the resonance frequency for vertically or horizontally polarized waves from shifting to the high frequency side (in other words, the resonant frequency can be the same for vertical and horizontal polarization) and allows the direction of travel of reflected waves to be accurately controlled.

The various configurations of the reflecting devices illustrated as embodiments of the present invention may be combined as appropriate as long as they do not contradict each other. Based on the reflecting devices disclosed in this specification and the drawings, any addition, deletion, or design change of configuration elements, or any addition, omission, or change of conditions of a process by a person skilled in the art is also included in the scope of the present invention, as long as it has the gist of the invention.

Other advantageous effects different from the advantageous effects brought about by the mode of embodiment disclosed herein, which are obvious from the description herein or which can be easily foreseen by those skilled in the art, are naturally considered to be brought about by the present invention.

What is claimed is:

1. A reflecting device comprising:
a plurality of patch electrodes arranged in a first direction and in a second direction intersecting the first direction; and
a common wiring connecting the plurality of patch electrodes in series in an array along the first direction,
wherein each of the plurality of patch electrodes comprises a first length along the first direction and a second length along the second direction, and
wherein the first length is longer than the second length.

2. The reflecting device according to claim 1, wherein a width of the common wiring is less than 3% of the second length.

3. The reflecting device according to claim 1, wherein the first length is greater than 1 time of the second length, and the first length is equal to or less than 1.2 times of the second length, and a width of the common wiring is 2% or less of the second length.

4. The reflecting device according to claim 1, wherein the common wiring is connected at a center portion in the second direction at each of the plurality of patch electrodes.

5. The reflecting device according to claim 1, wherein the common wiring bends.

6. The reflecting device according to claim 1, wherein each of the plurality of patch electrodes includes a notch in a center portion in the second direction, and the common wiring is connected at the notch.

7. The reflecting device according to claim 1, further comprising:
a reflecting plate arranged behind the plurality of patch electrodes; and
a liquid crystal layer arranged between the plurality of patch electrodes and the reflecting plate.

8. The reflecting device according to claim 1, further comprising:
a plurality of control electrodes arranged in correspondence with each of the plurality of patch electrodes; and
a liquid crystal layer between the plurality of patch electrodes and the plurality of control electrodes,
wherein each of the plurality of control electrodes is connected to a switching element.
